(19) United States
(12) Patent Application Publication
(10) Pub. No.: US 2018/0047047 A1
(43) Pub. Date: Feb. 15, 2018

(54) Systems and Methods for Use in Incentivizing Consumers to Adjust Utility Usage

(71) Applicant: MASTERCARD INTERNATIONAL INCORPORATED, Purchase, NY (US)

(72) Inventors: Bensam Joyson, Singapore (SG); Jie Zhang, Singapore (SG); Neeraj Javiya, St. Charles, MO (US); Andrew J. Smith, St. Louis, MO (US); Akshita Goyal, Jersey City, NJ (US)

(21) Appl. No.: 15/236,893

(22) Filed: Aug. 15, 2016

(51) Int. Cl. G06Q 30/02; G06Q 50/06

(52) U.S. Cl. CPC G06Q 30/0234; G06Q 50/06

(57) ABSTRACT

Exemplary systems and methods are provided for incentivizing consumers to adjust utility usage at their premises. One exemplary method includes receiving, at a computing device, from a utility provider, a challenge defining a reduction in a utility usage by a consumer, in exchange for an incentive, and causing, by the computing device, the challenge to be delivered to the consumer. Then, when the challenge is completed, the method includes causing the incentive to be awarded to the consumer, whereby the utility provider is able to affect utility usage by the consumer through the incentive-based challenge.

### FIELD

The present disclosure generally relates to systems and methods for use in incentivizing consumers to adjust utility usage, and in particular, for permitting utility providers to offer challenges, in which consumers are awarded incentives for completing the challenges and adjusting utility usage.

### BACKGROUND

This section provides background information related to the present disclosure which is not necessarily prior art.

Utilities such as gas, electricity, and water, etc. are often offered for sale by utility providers to premises. The utilities are then used by consumers, or other people, associated with the premises for various purposes, including, for example, heating, cooling, lighting, entertainment, hobbies, etc. The utility providers typically incur costs in connection with providing the utilities, be it associated with directly providing the utilities to the consumers or with purchasing utilities from other providers during peak use times. The costs, then, are reimbursed to the utility providers, in whole or in part, by rates paid by the consumers using the utilities.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in incentivizing consumers to adjust usage of utilities offered by a utility provider;

FIG. 2 is a block diagram of a computing device that may be used in the exemplary system of FIG. 1;

FIG. 3 is an exemplary method, suitable for use with the system of FIG. 1, for incenting consumers to adjust utility usage;

FIGS. 4-6 are exemplary interfaces that may be displayed in connection with the system of FIG. 1 and/or the method of FIG. 3, for permitting a utility provider to view and/or create challenges in connection with incentivizing consumers to adjust utility usage; and

FIGS. 7-9 are exemplary interfaces that may be displayed in connection with the system of FIG. 1 and/or the method of FIG. 3, for permitting a consumer to view and/or accept challenges created by a utility provider in connection with adjusting utility usage;

FIGS. 10-11C are exemplary interfaces that may be displayed in connection with the system of FIG. 1 and/or the method of FIG. 3, for permitting a consumer to view and/or redeem incentives awarded by a utility provider for completed challenges in connection with adjusting utility usage; and

FIGS. 12A-12B are exemplary interfaces that may be displayed in connection with the system of FIG. 1 and/or the method of FIG. 3, for permitting a consumer to view and/or pay bills issued by a utility provider in connection utility usage by the consumer; and.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Utilities are provided to consumers at their premises, for example, through utility providers. The utility providers supply the utilities at certain costs, which may include costs associated with generating and/or processing the utilities, or cost associated with purchasing the utilities from other providers, for example, when experiencing energy shortages during peak usage times. Consequently, profits associated with supplying the utilities to customers, or to other utility providers, are typically based on costs associated with the utilities themselves and further on rates the utility providers are able to charge consumers for the utilities. As such, utility providers may control profits by controlling supplies of the utilities, which, as can be appreciated, are dependent on usage by customers. Uniquely, the systems and methods herein provide for incentivizing consumers to alter their utility usages and potentially reduce consumption. In particular, challenges are created by utility providers and directed to the consumers, offering incentives for the consumers to alter usage of utilities in certain manners. For example, a utility provider may provide a challenge to a consumer to reduce electricity usages over a short interval (e.g., over a two hour interval, an eight hour interval, a day; etc.), offering a rebate or other incentive for completion of the challenge. In this manner, and through the challenges, utility providers may be able to conserve supplies of utilities and, in turn, control, at least in part, their profitability.

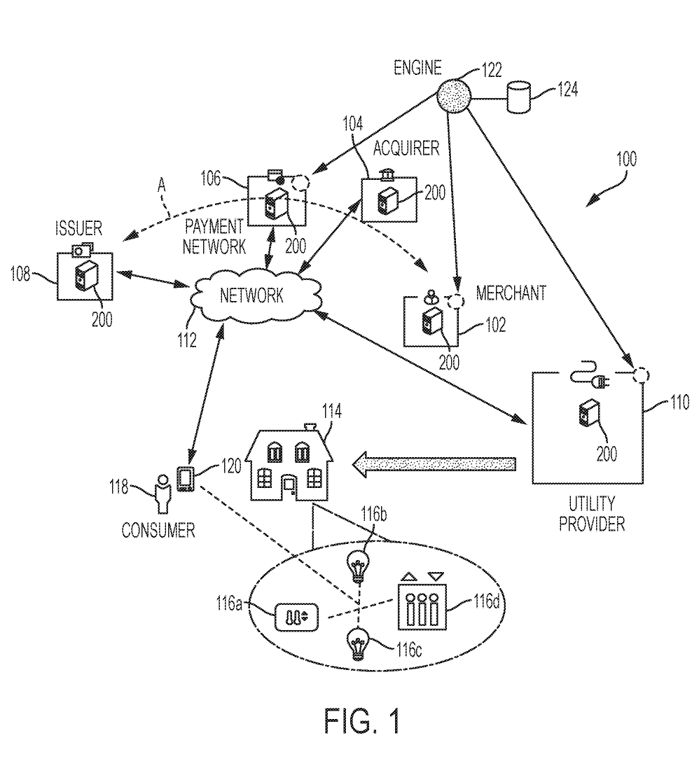

FIG. 1 illustrates an exemplary system 100, in which the one or more aspects of the present disclosure may be implemented. Although the system 100 is presented in one arrangement, other embodiments may include the parts of the system 100 (or other parts) arranged otherwise depending on, for example, processing of transactions in the system 100, provision of utilities to consumers in the system 100, etc.

The system 100 generally includes a merchant 102, an acquirer 104, a payment network 106, an issuer 108, and a utility provider 110, each coupled to (and in communication with) network 112. The network 112 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 112 may include multiple different networks, such as a private payment transaction network made accessible by the payment network 106 to the acquirer 104 and the issuer 108 and, separately, the public Internet, which may provide interconnection between one or more of the merchant 102, the payment network 106, and a consumer 118 (or a communication device 120 associated with the consumer 118), etc.

The utility provider 110 of the system 100 provides utilities to premises 114. As used herein, the utility provider 110 may include, for example, an electric company, a water company, a gas company, a telecommunications company, a waste removal company, combinations thereof, or any other utility company/provider, which may desire to effect the supply of utilities or services (broadly, utilities) to customers (broadly, consumers). In the illustrated embodiment, for example, the utility provider 110 provides an electric utility to multiple premises, including premises 114. The premises 114 may be any type of premises including, without limitation, a residential home, a condominium, an apartment, a commercial property, an office building, combinations/collections thereof, etc. In addition, while only one utility provider 110 is illustrated in FIG. 1, it should be appreciated that the system 100 may include multiple utility providers, with the premises 114 receiving utilities such as, for example, water, gas, etc., from the multiple utility providers. Similarly, the system 100 may include multiple premises, with the utility provider 110 providing one or more utilities to the multiple premises.

Also in the system 100, the premises 114 includes multiple utility devices 116a-d, each included at the premises, as indicated by the dotted oval in FIG. 1. The utility devices 116a-d may be located as desired or necessary at the premises 114, for example, inside or outside a structure at the premises 114, etc. For example, in the system 100, utility device 116a includes a thermostat device, while utility devises 116b-c are light bulb devices and utility device 116d is an elevator device. It should be appreciated that the premises 114 may include any desired utility devices within the scope of the present disclosure that use utilities and/or are associated with usage of utilities by another device.

The utility devices 116a-d of the premises 114 are coupled via a network (e.g., a home kit, etc.), as indicated by the dotted lines in FIG. 1. Often, the utility devices 116a-d will be connected to one or more hub devices (not shown), which are in turn connected to the network 112. In the illustrated embodiment, the premises 114 is associated with the consumer 118, who is in turn associated with communication device 120. As shown, each of the utility devices 116a-d is also connected, via one or more networks (e.g., as part of the home kit, etc.), to the communication device 120, which in turn is connected to (and is in communication with) the network 112. Specifically, the device hub and/or the communication device 120 may be configured, as an integrated system (e.g., as the home kit, as part of the home kit, etc.), for example, to control and/or monitor the utility devices 116a-d and/or utility usage thereof. For example, lights, temperature, entertainment, cold water, hot water, operation, etc. may be controlled by the integrated system. By connecting the device hub and/or the communication device 120 to the network 112, it is permitted for the consumer 118 and/or another person/entity to control and/or monitor the utility devices 116a-d and other devices at the premises 114 (and, thus, utility usage by the consumer 118 and/or the premises 114).

With continued reference to FIG. 1, generally in system 100, the merchant 102 offers for sale, and sells, products (e.g., goods and/or services, etc.) to consumers, including the consumer 118. The products may include any type of products to be purchased by the consumers and may further relate to the utility provider 110 (and utilities provided thereby) or not. In at least one embodiment, the utility provider 110 is considered a merchant, consistent with merchant 102, in its offer for sale, and sale, of utilities to consumers, including, the consumer 118.

Additionally, the consumer 118 is associated with a payment account through which the consumer 118 is able to fund purchases of products, including, for example, utilities. In one example, the consumer 118 provides payment credentials associated with the payment account to the utility provider 110, whereby the consumer 118 provides recurring payments to the utility provider 110 in the amount owed for utilities for the prior month (or for another interval), or for a later month (or another interval), etc. A recurring payment may further be coordinated in the system 100 by the consumer 118 with the merchant 102. Additionally, or alternatively, payment credentials may be provided to the merchant 102 and/or the utility provider 110, in person or via the network 112, for funding one-time purchases, etc. (although, it should be appreciated that other forms of funding may be used in combination with the disclosure herein).

In one exemplary transaction, the consumer 118 provides payment credentials associated with the consumer's payment account (e.g., a primary account number (PAN), an expiration date, a CVV, etc.) to the merchant 102 (as a single or recurring payment), in exchange for desired products. In turn, the merchant 102 submits an authorization request to the acquirer 104 (associated with the merchant 102) for the transaction. The authorization request is transmitted along path A in the system 100, as referenced in FIG. 1. The acquirer 104 communicates the authorization request with the issuer 108 (associated with the consumer's payment account), through the payment network 106, such as, for example, through MasterCard®, VISA®, Discover®, American Express®, etc. The issuer 108 is configured to determine whether the consumer's payment account is in good standing and whether there is sufficient funds and/or credit to cover the transaction. In turn, if the issuer 108 approves the transaction, an authorization reply or response (indicating the approval of the transaction) is transmitted back from the issuer 108 to the merchant 102, along path A, thereby permitting the merchant 102 to complete the transaction. The transaction is later cleared and/or settled (via appropriate transaction messages such as clearing messages and/or settlement messages) by and between the merchant 102, the acquirer 104, and the issuer 108 (by appropriate agreements). If the transaction is declined, however, the authorization reply (indicating a decline of the transaction) is provided back to the merchant 102, along the path A, thereby permitting the merchant 102 to halt or terminate the transaction or request other forms of payment.

Transaction data is generated, collected, and stored as part of the above interactions among the merchant 102, the acquirer 104, the payment network 106, the issuer 108, and the consumer 118. The transaction data represents at least a plurality of transactions, for example, authorized transactions, cleared and/or settled transactions, attempted transactions, etc. The transaction data, in this exemplary embodiment, is stored at least by the payment network 106 (e.g., in a data structure associated with the payment network 106, etc.). Additionally, or alternatively, the acquirer 104 and/or the issuer 108 may store the transaction data, or part thereof, in a data structure, or transaction data may be transmitted between parts of system 100 as used or needed. As used herein, transaction data may include, for example (and without limitation), PANs for consumers involved in the transactions, amounts of the transactions, merchant IDs for merchants involved in the transactions, merchant category codes (MCCs), dates/times of the transactions, incentives used (e.g., rebates, discounts, etc.), etc. It should be appreciated that more or less information related to transactions, as part of either authorization or clearing and/or settling, may be included in transaction records and stored within the system 100, at the merchant 102, the acquirer 104, the payment network 106 and/or the issuer 108.

In various exemplary embodiments, consumers (e.g., consumer 118, etc.) involved in the different transactions herein are prompted to agree to legal terms associated with their payment accounts, for example, during enrollment in their accounts, etc. In so doing, the consumers may voluntarily agree, for example, to allow merchants, issuers, payment networks, utility providers, etc., to use data collected during enrollment and/or collected in connection with processing the transactions herein, subsequently for one or more of the different purposes described herein.

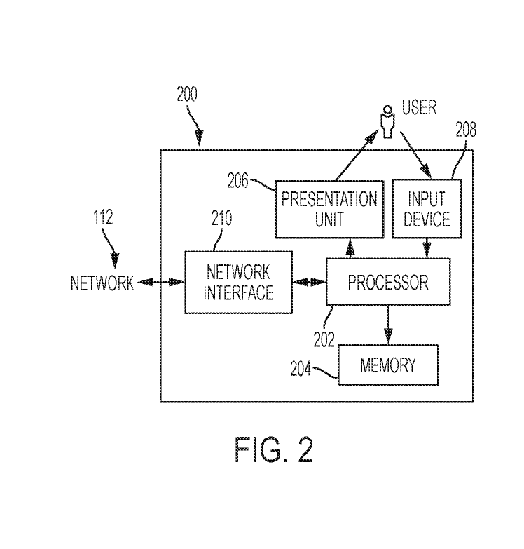

FIG. 2 illustrates an exemplary computing device 200 that can be used in the system 100. The computing device 200 may include, for example, one or more servers, workstations, personal computers, POS terminals, laptops, tablets, smartphones, PDAs, utility devices, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices.

In the system 100 illustrated in FIG. 1, each of the merchant 102, the acquirer 104, the payment network 106, the issuer 108, and the utility provider 110 are illustrated as including, or being implemented in, computing device 200, coupled to (and in communication with) the network 112. In addition, the communication device 120 associated with the consumer 118, as well as one or more of the utility devices 116a-d, may each be considered a computing device consistent with computing device 200.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, utility usage data, challenges, incentives offered and/or used, premises profiles, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in connection with one or more of the functions or processes described herein.

In the exemplary embodiment, the computing device 200 also includes a presentation unit 206 that is coupled to (and in communication with) the processor 202 (however, it should be appreciated that the computing device 200 could include output devices other than the presentation unit 206, etc.). The presentation unit 206 outputs information (e.g., challenges, etc.), visually, for example, to a user of the computing device 200, such as the consumer 118 in the system 100 (e.g., via communication device 120, etc.); etc. It should be further appreciated that various interfaces (e.g., as defined by internet-based applications, websites, etc.) may be displayed at computing device 200, and in particular at presentation unit 206, to display certain information to the user. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices. Additionally or alternatively, the presentation unit 206 may include printing capability, enabling the computing device 200 to print text, images, and the like on paper and/or other similar media.

In addition, the computing device 200 includes an input device 208 that receives inputs from the user (i.e., user inputs) such as, for example, premises information, challenge information, utility usage data, etc. The input device 208 may include a single input device or multiple input devices. The input device 208 is coupled to (and is in communication with) the processor 202 and may include, for example, one or more of a keyboard, a pointing device, a mouse, a stylus, a magnetic stripe reader, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 112. Further, in some exemplary embodiments, the computing device 200 includes the processor 202 and one or more network interfaces incorporated into or with the processor 202.

Referring again to FIG. 1, the system 100 also includes an incentive engine 122. The incentive engine 122 is specifically configured, by computer executable instructions (for example, as provided below), to perform one or more of the operations described herein. The incentive engine 122 may be considered to be consistent with the computing device 200. In addition, the incentive engine 122 is illustrated as a stand-alone device in the system 100, and which is accessible to the communication device 120 via one or more application programing interfaces (APIs) (e.g., through a network-based application associated with the merchant 102, with the payment network 106, with the utility provider 110, etc.). However, as indicated by the solid arrow lines in FIG. 1 extending therefrom, the incentive engine 122 may alternatively be associated with, or incorporated with, the merchant 102, the payment network 106, and/or the utility provider 110 (and accessible directly and/or via one or more APIs, etc.). Further, in various other embodiments, it should be appreciated that the incentive engine 122 may be associated with, or incorporated with (in whole or in part), still other parts of the system 100, for example, the acquirer 106, the issuer 108, etc.

The system 100 further includes a data structure 124, which is coupled to the incentive engine 122 (and/or incorporated into the incentive engine 122). The data structure 124 may be included in a computing device consistent with computing device 200, or may be included in a memory, consistent with, for example, memory 204 (either as part of the computing device associated with the incentive engine 122 or apart therefrom).

The data structure 124 may be segregated into multiple different data structures including, for example, a utility provider data structure, a consumer data structure, and a challenge data structure. An exemplary utility provider data structure may include, without limitation, names of utility providers, addresses, contact information, consumer listings, geographic operating regions, utilities provided, account information (e.g., for receipt of utility payments from consumers, etc.), etc. (broadly, utility profiles, etc.). An exemplary consumer data structure, which is compiled (or further compiled) when consumers register with the incentive engine 122, may include, without limitation, names of consumers, addresses of premises associated with the consumers, one or more consumer preferences related to challenges, etc. (broadly, consumer profiles, etc.). And, an exemplary challenge data structure may include, without limitation, different challenges, where each includes an adjustment to a utility usage (e.g., a reduction, etc.), an incentive (e.g., a reward, other incentive, etc.), a time interval (e.g., a predefined interval, multiple predefined intervals, repetitive intervals, etc.) for the adjustment, restrictions on challenge eligibility based on consumers and/or premises, etc. These and other data structures (either included as part of the data structure 124 or separate therefrom) may include further data suitable for use as described herein.

In general in the system 100, the incentive engine 122 is configured in various manners to facilitate challenges to consumers to alter usage of utilities. For example, the incentive engine 122 is configured to facilitate the registration of the utility provider 110 (e.g., to compile the utility provider data structure in the data structure 124, etc.), whereby the utility provider 110 is able to compile/activate/deactivate challenges to consumers (e.g., to further compile the challenge data structure in the data structure 124, etc.), including to consumer 118, and/or view details of the challenges, acceptance and competition, as well as the incentives awarded. The incentive engine 122 is configured to also register consumers (including consumer 118) to receive challenges (e.g., to compile the consumer data structure in the data structure 124, etc.), which includes, for example, registering the premises 114 associated with the consumer 118 (and/or the utility devices 116a-d at the premises 114 that may be involved in the challenges). The incentive engine 122 is configured to further deliver challenges (from the data structure 124), to the consumers (including the consumer 118), to receive the consumers' acceptance of the challenge(s), to effect changes to utility devices at the consumers' premises (e.g., devices 116a-d at the premises 114, etc.) based on acceptance of the challenges (and based on a consumer profile in data structure 124), to verify/determine the challenges are completed, and to award incentives when the challenges are completed.

In particular, the incentive engine 122 may be configured to create an incentive (e.g., a challenge associated with an incentive, etc.) for the consumer 118, update the challenge and/or incentive, and delete the challenge and/or incentive, independently or upon direction from the utility provider 110, as defined, for example, by the following exemplary instructions:

```
IncentiveEngine.create(′description′, ′amount′ , ′rebateType, ′enabled) {
    Incentive.create(′description′,′amount′,′rebateType′,′enabled′).save( )
    return successMessage
}
IncentiveEngine.update(′id′, ′description′, ′amount′ , ′rebateType, ′enabled) {
    Incentive.find(id).update(′description′, ′amount′ , ′rebateType, ′enabled)
    return successMessage
}
IncentiveEngine.delete(′id′) {
    Incentive.find(id).delete( )
    return successMessage
}
```

In addition, the incentive engine 122 may be configured to provide (e.g., push, etc.) the challenges and incentives to the consumer 118 via a network-based application at the consumer's communication device 120, as well as update the utility devices 116a-d at the consumers' premises 114 (broadly, update the home kit associated with the devices 116a-d) in response to a selection of one of the challenges by the consumer and determine when the selected one of the challenges is complete, as defined by the following exemplary instructions:

```
IncentiveEngine.get( ){
    Incentive.list( )
}
HomeKit.update(′incentiveId′){
    Incentive.get(′incentiveId′).apply( )
}
IncentiveEngine.complete(′Id,′customerId′){
    Customer.get(′customerId′).completeIncentive(′id′)
}
```

It should be appreciated that the above code segments are exemplary only, and illustrative of operations described herein, but may be altered and/or expanded upon to perform other operations described herein, or as necessary or desired, and/or to perform operations in one or more different manners.

It should also be appreciated that the manner in which the incentive engine 122 is configured is dependent, at least in part, on where and/or how the incentive engine 122 is implemented in the system 100 (e.g., in the utility provider 110, etc.).

In addition, while the system 100 is described in connection with the utility provider 110 and utility services, it should be appreciated that the system 100 may also include (with the features thereof also being applicable to) other providers that desire to incentivize consumers to reduce certain usage of products and/or services associated with the providers. As an example, such a provider may include an insurance company, where the insurance company may be able to reduce premiums for consumers based on uptime of security systems being armed for premises associated with the consumers (including automobiles, etc.).

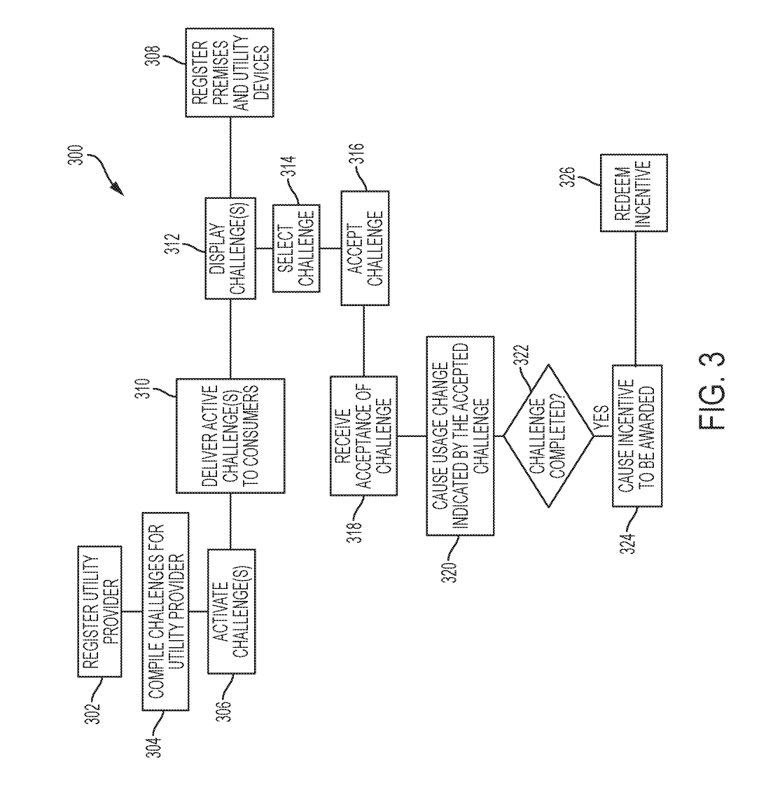

FIG. 3 illustrates an exemplary method 300 of incentivizing consumers to adjust utility usage. The exemplary method 300 is described herein in connection with the system 100, and may be implemented in the incentive engine 122 of the system 100. Further, for purposes of illustration, the exemplary method 300 is also described with reference to computing device 200. However, it should be appreciated that the method 300, or other methods described herein, are not limited to the system 100, or computing device 200. And, conversely, the systems and computing devices described herein are not limited to the exemplary method 300.

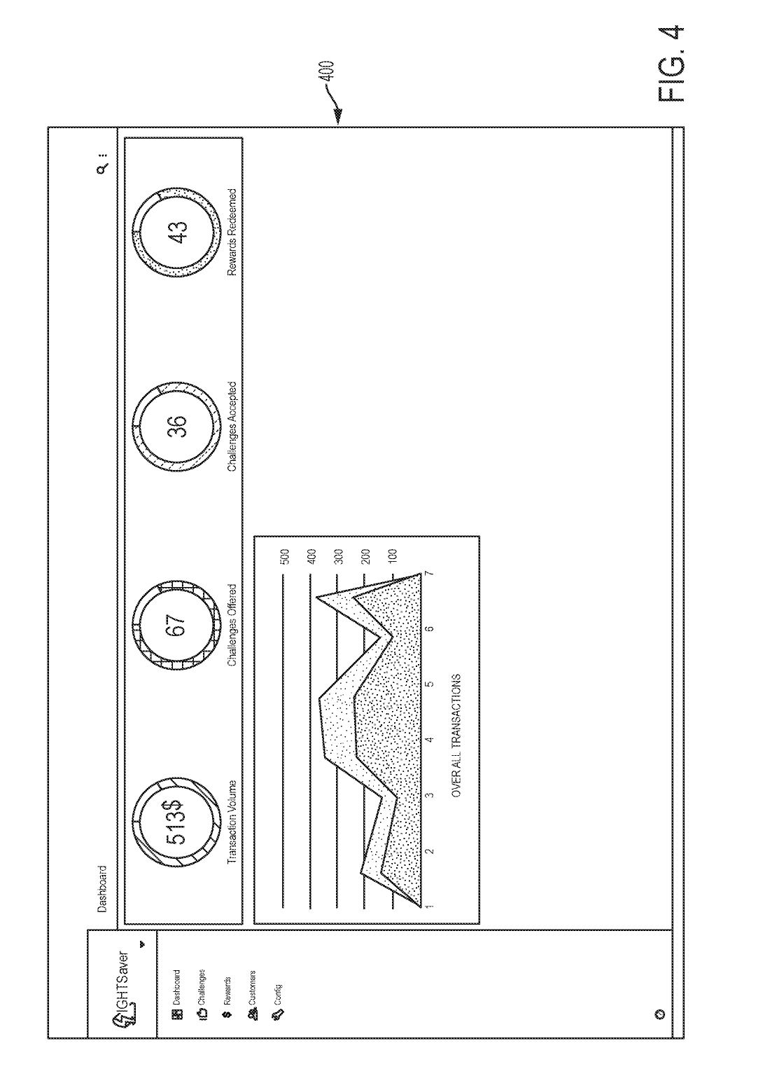

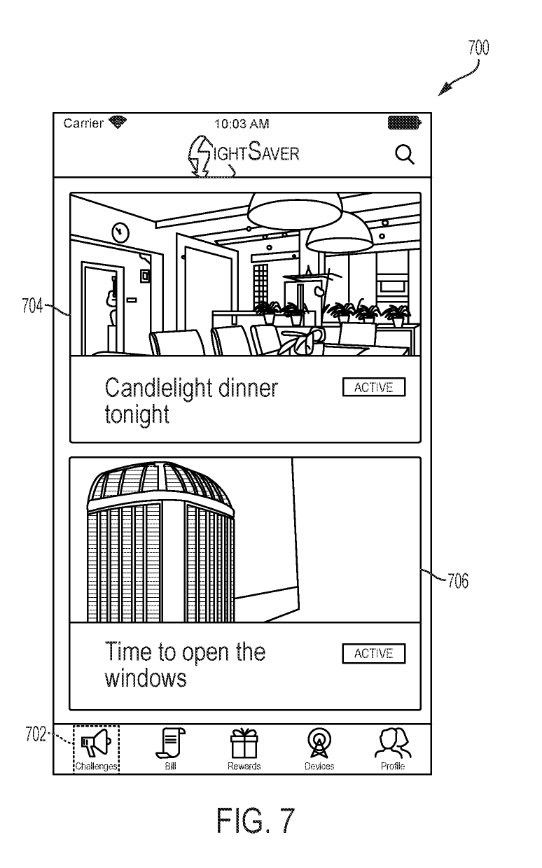

In addition, the method 300 is described with reference to multiple exemplary interfaces, including interfaces to be displayed to the utility provider 110 (e.g., at presentation unit 206 of computing device 200, etc.) and interfaces to be displayed to the consumer 118 (e.g., at communication device 120, etc.). Specifically, FIGS. 4-6 include interfaces 400-600, which enable the utility provider 110 to view status and/or compile challenges, while FIGS. 7-12B include interfaces 700-1200, which permit the consumer 118 to interact with the incentive engine 122 and/or otherwise perform operations described herein. However, the method 300, and more generally the methods and systems described herein, should not be understood to be limited to the exemplary interfaces 400-1200 provided herein, as other interfaces may be provided from or by the incentive engine 122 in other embodiments.

Referring to FIG. 3, initially in the method 300, the utility provider 110 registers, at 302, to the incentive engine 122. Registration may include, for example, the utility provider logging into a website or internet-based application associated with the incentive engine 122 and providing pertinent (or not pertinent) information about the utility provider 110, its customers and/or premises served, etc., such as, for example, names, addresses, service regions, etc. Once registered, the utility provider 110 is able to access a utility provider profile (e.g., upon log in, etc.) and view information relevant to the utility provider 110.

FIG. 4 illustrates an exemplary dashboard interface 400 (e.g., displayed to a user associated with the utility provider 110 in connection with the internet-based application associated with the incentive engine 122, etc.), which provides various information to the utility provider 110, including, for example, the number of challenges offered, the number of challenges accepted, and the number of rewards (broadly, incentives) redeemed. The dashboard interface 400 further permits the utility provider 110 to view transaction volume, which relates, for example, to a number of bills issued by the utility provider 110 and the total amount of bills collected. It is contemplated that in some embodiments the consumer 118 (and other consumers serviced by the utility provider 110) may be auto-billed by the utility provider 110 for utilities, with the utility provider 110 then able to monitor and managing such billing through the interface 400, for example, via the transaction volume indicator and an overall transactions chart.

Beyond providing such information for the utility provider 110, the dashboard interface 400 of FIG. 4 also permits the utility provider 110 to select various options along the left portion of the interface 400 relating to, for example, challenges, rebates, customers, and configurations. For example, the utility provider 110 may create challenges, edit challenges, activate challenges, deactivate challenges, delete challenges, etc. Upon selection of one of the options, a further interface is then displayed to the utility provider 110 relating to the desired selection.

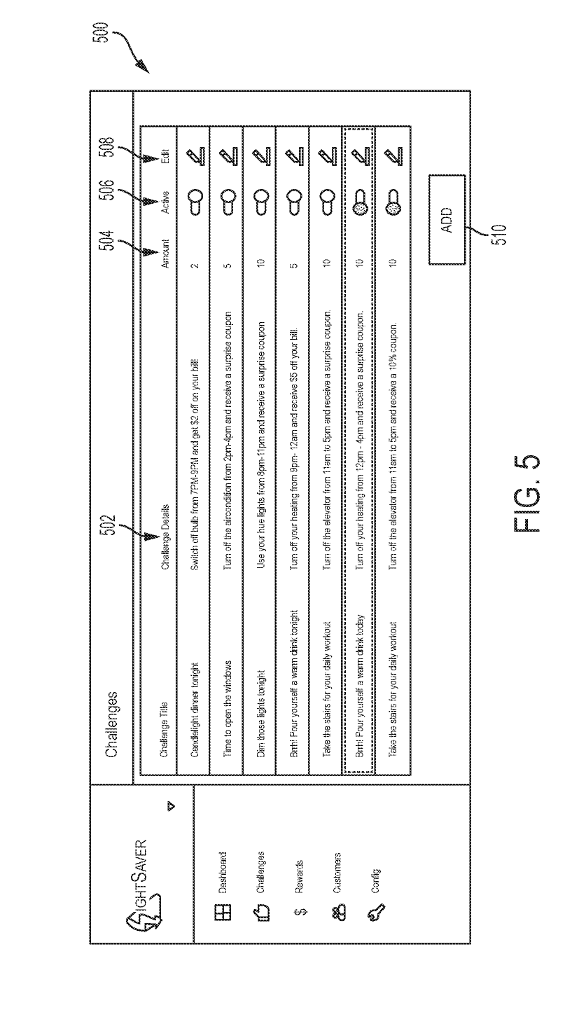

For example, FIG. 5 illustrates an exemplary challenges interface 500 displayed to the utility provider 110 upon selection of the “Challenges” option from the interface 400. As shown, the challenges interface 500 includes numerous exemplary challenges available for submission to consumers, such as, “Candlelight dinner tonight,” “Time to open the windows,” “Take the stairs for your daily workout,” etc. Each challenge includes details 502 thereof, which provide a description of the challenge and indicate the utility usage adjustment required for the challenge and, often, the resulting reward. For example, the “Candlelight dinner tonight” challenge calls for light bulbs to be powered off between 7:00 pm and 9:00 pm., in exchange for $2.00 off the consumer's utility bill (or statement). In other embodiments, such a challenge may include “Lights out for lunch,” where a similar challenge (e.g., powering off light bulbs, etc.) is provided with a different time constraint and/or activity constraint (e.g., during lunch time instead of dinner time, etc.). As such, it should be appreciated that the different challenges described herein (and challenges in general as contemplated by the present disclosure) may be similar in scope (i.e., may be directed to similar utility/energy-conservation actions) but may include different time and/or activity constraints for implementing and/or achieving the actions. Further, through the dashboard interface 400 (FIG. 4), for example, the utility provider 110 may edit one or more existing challenges to change the time and/or activity constraints in this manner (e.g., to a different activity such as lunch verses dinner, to a different time of day, to a different day, etc.).

The challenge interface 500 also includes, for each challenge, an amount 504 identifying participation, a status (i.e., active/inactive) 506, and an edit option 508. More particularly, the amount 504 is indicative of the number of consumers that have completed the particular challenge. The status 506 indicates whether the challenge is active (e.g., whether the challenge is available to be delivered to and/or retrieved by consumers, etc.) or inactive (which may be changed by the utility provider 110, as desired), and the edit option 508 permits the utility provider 110 to edit the challenge (e.g., increase rewards, delete a challenge, etc.). In some embodiments, the challenge interface 500 may also include a column identifying a number of consumers who have attempted a challenge, to thereby provide an indicator of how successful consumers are at meeting the objective of the challenge. In addition, the challenge interface 500 includes an “ADD” option 510, through which the utility provider 110 is able to add new challenges.

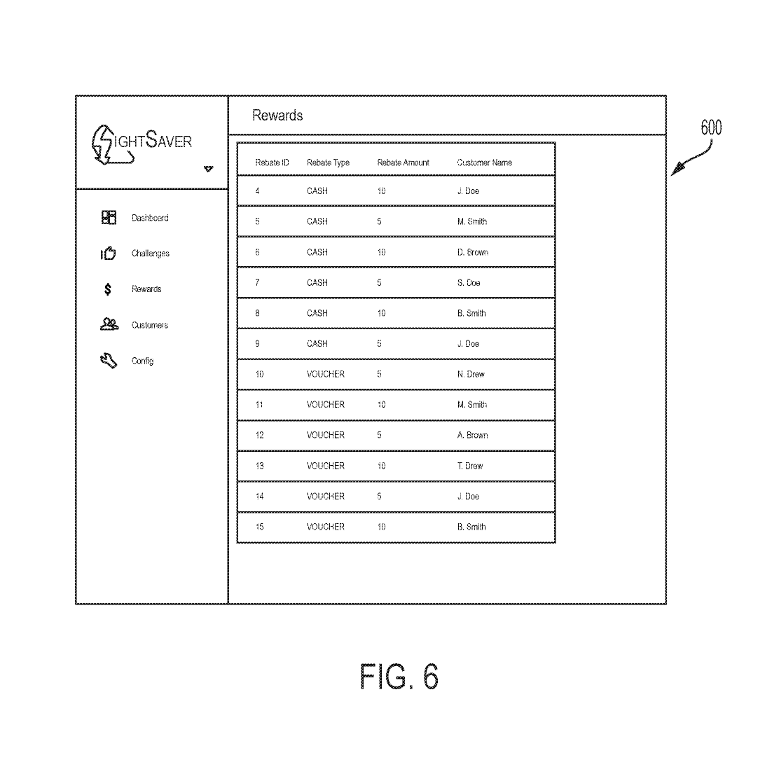

FIG. 6 illustrates an exemplary rewards interface 600 displayed to the utility provider 110 (for example, by the incentive engine 122) upon selection of the “Rewards” option from the interface 400. As shown, the rewards interface 600 includes a listing of all rewards that have been issued to consumers for completion of challenges provided by the utility provider 110. In particular, the listing includes, for each reward, an identification number for the reward, a reward type (e.g., cash, rebate, voucher, etc.), a reward amount, and a name of the particular consumer to whom the reward was issued (and/or other consumer identifier). For example, in the first row of the listing, a $10 cash reward (having rebate ID 4) has been issued to J. Doe. In some embodiments, the rewards interface 600 may further include in the listing of rewards (or may include as a separate listing) an indication of the rewards that have actually been accepted (or redeemed) by the consumers, dates on which the rewards were issued and/or accepted (or redeemed), a status of the issued rewards (e.g., issued, accepted, etc.), etc.

Referring again to FIG. 3, once registered, the utility provider 110 can add or edit or activate/deactivate or delete a challenge, utilizing its utility provider profile (e.g., via the challenges interface 500, etc.). In so doing, the utility provider 110 compiles the challenges, at 304. The utility provider 110 can then activate one or more of the challenges, at 306, to be delivered to consumers (e.g., consumers within the utility provider's profile, etc.) to encourage various different adjustments to utility usage. When activating a challenge, the utility provider 110 may, for example, specify a region to which the challenge is to be delivered and/or other criteria that would be inclusive of certain consumers (or premises), while exclusive of others (e.g., based on historical acceptance of challenges, historical utility usage, consumer permissions, etc.). In addition, the utility provider 110 may particularly target new homeowners to increase awareness of potential utility conservation projects, or certain regions to promote, increase, and/or improve public relations in those certain regions. Alternatively, a challenge may be active for all consumers included in the utility provider's profile. In addition, if desired, the utility provider 110 may deactivate one or more challenges, for example, via its profile.

Separately in the method 300, the consumer 118 (and the consumer's premises 114) registers, at 308, with the incentive engine 122. The registration may be coordinated through a network-based application installed at the communication device 120, for example, or the consumer 118 may interact and/or register with the incentive engine 122 in other manners. As an example, the registration may be accomplished via one or more interfaces (not shown), displayed at the consumer's communication device 120, through which the consumer 118 provides various information, including, without limitation, name, address of the premises 114, identification of the utility provider 110 (or multiple utility providers) associated with the premises 114, challenge preferences, permissions, etc. (e.g., as part of a profile for the consumer 118, etc.).

In addition, during registration of the consumer 118 to the incentive engine 122, the consumer 118 registers utility devices 116a-d at the premises 114 to the incentive engine 122 (e.g., via the same internet-based application, etc.). Specifically, the consumer 118 identifies the utility devices 116a-d individually, or in combination, and identifies a manner in which the incentive engine 122 is able to monitor and/or alter the utility devices 116a-d. In various embodiments, the consumer 118 provides permissions (and potentially including limitations) for the incentive engine 122 to monitor and/or alter the settings of the utility devices 116a-d (e.g., select ones of the utility devices 116a-d, all of the utility devices 116a-d, etc.) in connection with one or more challenges potentially accepted by the consumer 118. Such access may be coordinated through the network-based application installed at the communication device 120 (using the various networks interconnecting the utility devices 116a-d and the communication device 120 described above in the system 100). Or, such access may be coordinated through one or more network-based applications associated with one or more suppliers, distributors, retailers, and/or manufactures (broadly, device providers) of the utilities devices 116a-d (e.g., via an API and/or software development kit (SDK) offered by the device providers (directly or indirectly), etc.), and/or coordinated directly through the utility devices 116a-d (via appropriate network-based applications at and/or accessing the utility devices 116a-d, etc.).

Once the utility provider 110 and the consumer 118 are registered, and the utility provider 110 activates a challenge, at 306, the incentive engine 122 delivers the activated challenge to registered consumers, including the consumer 118, at 310. In the method 300, the incentive engine 122 pushes the challenge to the network-based application installed at the communication device 120 associated with the consumer 118. Alternatively, delivery of the challenges may be a result of the application pulling the challenges from the incentive engine 122 and/or the data structure 124 (e.g., via a message (e.g., a GET message), via an API and/or SDK, etc.). In addition, the application may queue challenges as received, for viewing by the consumer 118, and/or provide a visual/audio indication upon receipt. Then, when the network-based application is accessed by the consumer 118 (e.g., via login, etc.), via the communication device 120, the challenge is displayed to the consumer 118, at 312, along with other challenges delivered to the consumer 118 by the utility provider 110 (or by other utility providers similarly registered). In turn, the consumer 118, via the communication device 120, is able to select the challenge, at 314, as desired (or another challenge received by the consumer 118), to view details of the challenge. And, if the details of the challenge appear acceptable to the consumer 118, the consumer can accept the selected challenge, at 316.

FIG. 7 illustrates an exemplary interface 700 through which the consumer 118 may receive challenges from the incentive engine 122, at the consumer's communication device 120. The interface 700 may be associated with, for example, the internet-based application installed at the communication device 120 described above in connection with the system 100 and the method 300. In the illustrated interface 700, a “Challenges” icon 702 is selected (at a bottom portion of the interface 700), and two challenges are presented to the consumer 118 in tiles 704, 706. The upper tile 704 includes the challenge “Candlelight dinner tonight,” and the lower tile 706 includes the challenge “Time to open the windows.” Each challenge is currently “active,” as indicated in the tiles 704, 706, and available for selection by the consumer 118.

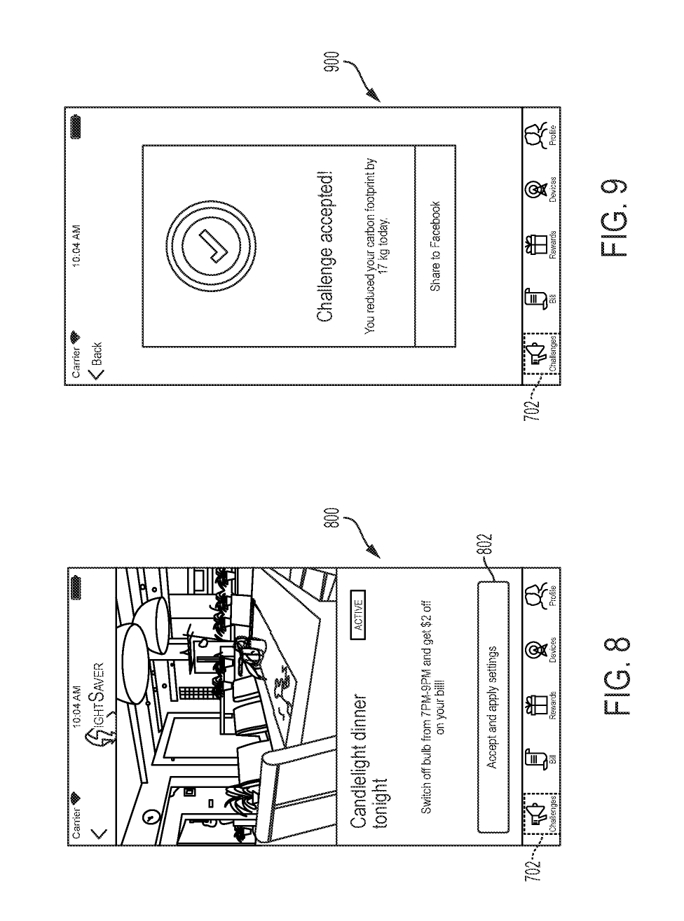

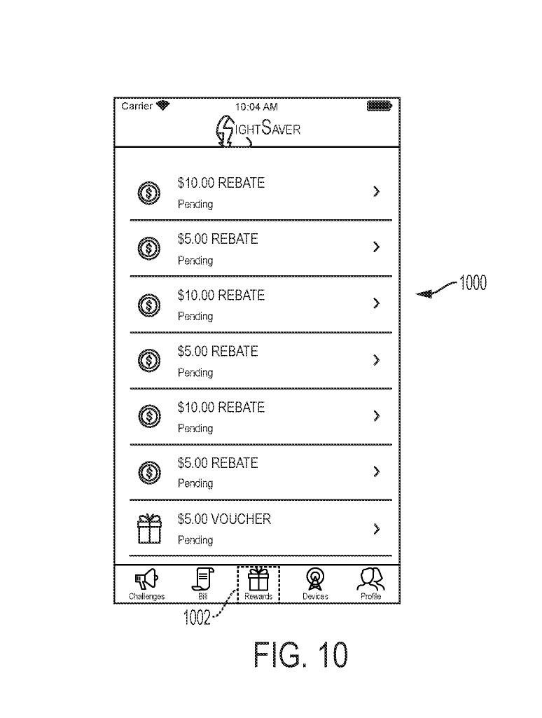

Upon selection of the “Candlelight dinner tonight” challenge from the interface 700 (from the upper tile 704), for example, another exemplary interface 800, as shown in FIG. 8, is displayed to the consumer 118 at the communication device 120. As illustrated, the interface 800 includes the details of the selected challenge (i.e., turn off light bulbs from 7 pm to 9 pm tonight). If the details of the challenge are amenable to the consumer 118, the consumer 118 can accept the challenge and apply the challenge settings to the premises 114 (e.g., to light bulb utility devices 116b-c, etc.) by selecting “accept” option 802. The acceptance of the challenge causes another interface 900 to display, as shown in FIG. 9, indicating the acceptance of the challenge. It should be appreciated that in one or more embodiments, acceptance of a challenge may include the consumer 118 accepting additional terms and/or conditions associated with the challenge and/or providing an acknowledgment to the incentive engine 122 to take further operations to cause utility usage at the premises to be adjusted consistent with the accepted challenge.

The interfaces 700-900 each relate to the challenges provided by the utility provider 110 to the consumer 118 (e.g., as shown in tiles 704, 706 in FIG. 7, etc.). As such, in each of the interfaces 700-900, the “Challenges” icon 702 is shown selected (at the bottom portion of the interfaces 700-900). Additional icons are also shown in the interfaces 700-900, for example, relating to billing, rewards, devices (e.g., registered devices associated with the consumer 118, etc.), and a profile for the consumer 118. As desired, the consumer 118 may select one of the additional icons from any of the interfaces 700-900 to navigate to other interfaces in which the consumer 118 can view, edit, etc. data relating to the particular selected icon. This will be described in more detail hereinafter, particularly with reference to the rewards icon and the billing icon.

Referring back to FIG. 3, once a selected challenge is accepted by the consumer 118, the incentive engine 122 receives the acceptance of the challenge from the consumer 118, at 318. The incentive engine 122 then causes a change in the utility usage at the premises 114 (broadly, adjusts the utility usage at the premises 114), at 320, consistent with the terms of the accepted challenge. The change in the utility usage may be achieved through the utility devices 116a-d at the premises 114 (and/or through other utility devices at the premises 114, such as irrigation systems, water heaters, etc.), or otherwise. When achieved through the utility devices 116a-d, such changes may be caused by the incentive engine 122 through network-based commands directed to a hub device and/or the communication device 120 (and/or an API and/or SDK associated with the device provider (not shown) and/or the devices 116a-d, etc.), etc.

As an example, the incentive engine 122 may cause a light bulb (e.g., one or both of light bulb utility devices 116b-c, etc.) to be turned off (or dimmed, as applicable) for the duration of a predefined interval (e.g., between 7:00 pm and 9:00 pm for the “Candlelight dinner tonight” challenge described above, etc.). In another example, the incentive engine 122 may cause a temperature for the premises 114 to be adjusted through a thermostat utility device (e.g., utility device 116a), or an air conditioning and/or heating system (HVAC system) to be turned off for a predefined interval. In yet another example, the incentive engine 122 may cause an elevator (e.g., elevator utility device 116d, etc.) to be turned off for a predefined interval. In still another example, the incentive engine 122 may cause an irrigation system to operate only at a predefined time and/or on predefined days of the week (e.g., from 12:00 am to 1:00 am on Monday and Thursday, etc.), or to cause the irrigation system to forego watering for a week.

Further in the method 300, the incentive engine 122 monitors the premises 114, and in particular, one or more of the utility devices 116 a-d involved in the accepted challenge, to determine, at 322, whether the accepted challenge is completed or not. For example, in connection with acceptance of the “Candlelight dinner tonight” challenge, if the consumer 118 causes a light bulb to be turned back ON during the 7:00 pm to 9:00 pm interval of the challenge, the incentive engine 122 detects the change in the light bulb and determines the challenge was not completed. Alternatively, when completed, the incentive engine 122 awards the incentive to the consumer 118, at 324, indicated in the challenge. As described above, the incentive may include, for example, a rebate/discount on a utility bill, a coupon for redemption at a merchant (e.g., the merchant 102, etc.), cash back, a gift certificate/card for one or multiple merchants, etc. The incentives may be associated with the challenges and included with the challenge, or alternatively, retrieved by the incentive engine 122, from the data structure 124 (or elsewhere) (e.g., directly, or via API and/or SDK message, etc.) prior to being awarded to the consumer 118, etc. Once the incentive for the accepted (and completed) challenge is awarded, the consumer 118 is able to redeem the incentive, at 326.

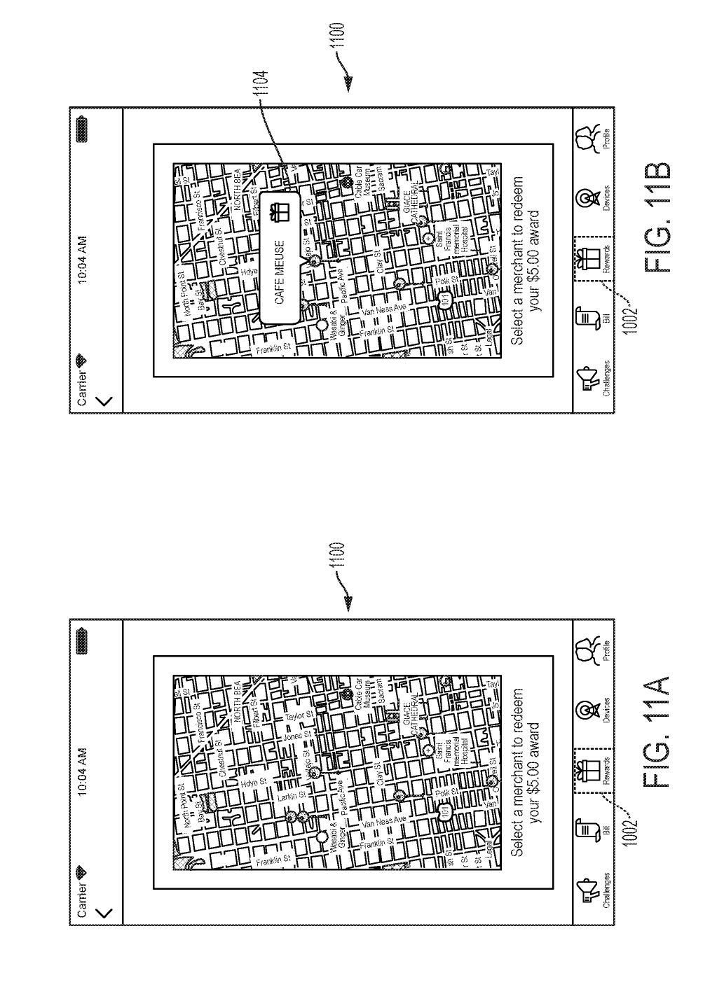

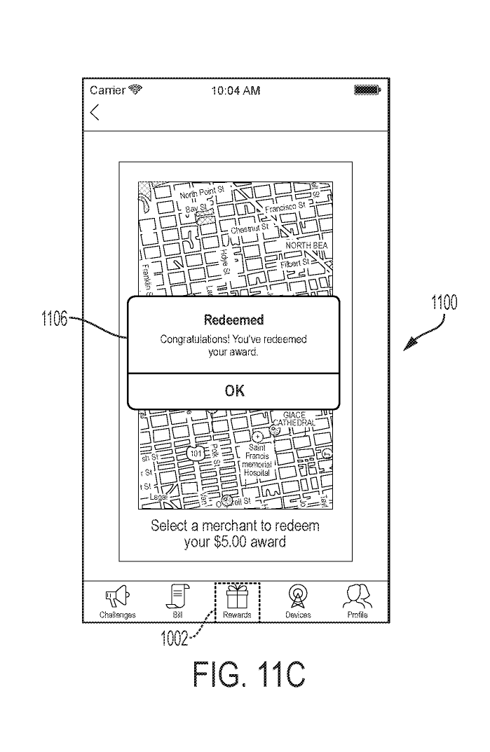

FIGS. 10-11C illustrate exemplary rewards interfaces 1000, 1100 that may be displayed to the consumer 118 by the incentive engine 122, at the communication device 120, for example, upon selection of a “Rewards” icon 1002 at a bottom portion of the interface 1000 (or the interface 1100). As described above, the “Rewards” icon 1002 may also be selected from any of the interfaces 700-900 (of FIGS. 7-9), for example, when the consumer 118 desires to view rewards details associated with his/her account with the utility provider 110 (or with other registered utility providers).

As shown in FIG. 10, the interface 1000 includes a listing of all rewards (broadly, incentives) awarded to the consumer 118 and available for redemption. When the consumer 118 desires to redeem one of the rewards, he/she selects the desired reward. In turn, the incentive engine 122 causes a merchant selection interface 1100 to display at the consumer's communication device 120, as shown in FIG. 11A. In this example, the consumer 118 selected the “$5.00 Voucher” from the interface 1000, which causes different merchants, at which the reward may be redeemed, to be displayed on a map in the interface 1100. When the consumer 118 selects a merchant from the map, the exemplary interface 1100 then displays a flag 1104 associated with the selected merchant, as shown in FIG. 11B, and indicates the name of the merchant (e.g., Café Meuse, etc.). When the consumer 118 selects the flag, the reward is redeemed, by the communication device 120 (via the incentive engine 122), and an indication 1106 of the redemption is displayed in the interface 1100, as shown in FIG. 11C.

As an example, upon redemption of the “$5.00 Voucher” reward from the interface 1000, the incentive engine 122 may cause a new prepaid account to be appended to a payment application at the consumer's communication device 120, consistent with the redemption (e.g., a $5.00 prepaid account to Café Meuse, a generic $5.00 prepaid account issued by the issuer 108 that can be used at Café Meuse or other ones of the merchants identified in the interface 1100 in FIG. 11A, etc.). Or, the incentive engine 122 may generate the “$5.00 Voucher” and push it to the consumer's communication device 120 for access via the internet-based application installed at the communication device 120 (as described above in connection with the system 100 and the method 300). Here, the consumer 118 can then show the voucher to a participating merchant for redemption (e.g., based on a voucher serial number, a QR code, etc.). As another example, upon redemption of the “$5.00 Rebate” reward from the interface 1000, the incentive engine 122 may cause a discount to be applied to the consumer's current utility bill in the amount of $5.00 at the consumer's communication device 120 (e.g., via the network-based application, directly, or through calling an API and/or SDK associated with the incentive and/or billing of the utility provider 110, etc.), etc.).

In addition in the method 300, at various times, the consumer 118 may receive bills from the utility provider 110 relating to usage of utilities at the premises 114. In connection therewith, once generated by the utility provider 110, the incentive engine 122 may push the bills to the network-based application installed at the consumer's communication device 120. The application may queue the bills, as received, for viewing and payment by the consumer 118, and/or provide a visual/audio indication upon receipt. Then, when the application is accessed by the consumer 118 (e.g., via login, etc.), via the communication device 120, the new bill/bills is/are available to the consumer 118 and/or displayed to the consumer 118 (along with other bills from the utility provider 110 or from other utility providers similarly registered). In turn, the consumer 118 can effect payment of the new bill/bills, via the application, for example, using his/her payment account, in which case the communication device 120 (via the incentive engine 122) generates an authorization request for the transaction and transmits the request to the acquirer 104 (when associated with the utility provider 110), along path A in FIG. 1, in a similar manner to that described for the example transaction above in the system 100.

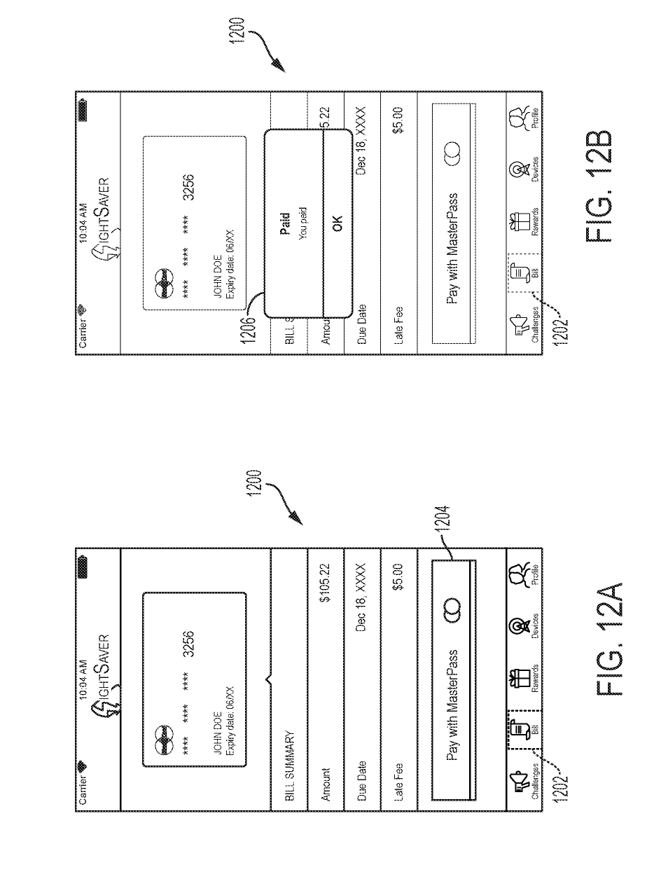

FIGS. 12A and 12B illustrate an exemplary billing interface 1200 that may be displayed to the consumer 118 by the incentive engine 122, at the consumer's communication device 120, for example, upon selection of a “Bill” icon 1202 at a bottom portion of the interface 1200. Through the billing interface 1200, the consumer 118 can view and pay recent bills for utilities provided by the utility provider 110 (and potentially view any rebates redeemed by the consumer 118 toward his/her bills). As described above, the “Bill” icon 1202 is also available for selection from any of the interfaces 700-1100, upon which the billing interface 1200 is then displayed at the communication device 120.

The illustrated interface 1200 generally includes payment account information for the consumer 118 to be used to pay the bill, and a billing summary for the current bill to be paid. The payment account information included in the interface 1200 may be provided during registration of the consumer 118 (e.g., at 308 in the method 300, etc.), or it may be provided from a payment application at the communication device 120 (e.g., an electronic wallet (or e-wallet) application such as MasterPass®, Apple Pay®, Samsung Pay®, PayPal®, Google Wallet®, Android Wallet™, etc., which configures the communication device 120 to act as a payment device for and/or with one or more different payment accounts). In some embodiments, the billing interface 1200 may also include (for review) past bills for the consumer 118 (and their status), a transaction history for the consumer 118, utility usage for the consumer 118 and/or the premises 114, etc. In still other embodiments, the billing interface 1200 may not include pre-provided payment account information for the consumer 118, but instead may require the consumer 118 to enter desired payment account information for use in paying a bill. The consumer 118 can then effect payment of the bill via payment button 1204 in the interface 1200, using the displayed payment account information. And, once the bill is paid, a confirmation 1206 is displayed at the communication device 120, indicating that the payment for the bill has been successfully submitted (e.g., in the manner described above, etc.).

In view of the above, through the systems and methods herein, utility providers are permitted to offer challenges to consumer, whereby the consumers receive incentives to adjust utility usage at their premises. Through such interaction, the utility providers are able to impact the supply of utilities available to the utility providers, by strategically altering use of the utilities by consumers. In such systems and/or methods, the utility providers may then be able to reduce needs to purchase utilities from other providers to satisfy consumer needs, for example, in times of shortages, by directly reducing the consumers' needs through incentives (and, thus, potentially avoiding any such shortages). In this manner, the utility providers may further be able to efficiently affect costs and profits associated with such utilities sales.

It should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving from a utility provider, a challenge defining a reduction in a utility usage by a consumer, in exchange for an incentive; (b) causing the challenge to be delivered to the consumer; (c) when the challenge is completed, causing the incentive to be awarded to the consumer, whereby the utility provider is able to affect utility usage by the consumer through the incentive-based challenge; (d) causing the reduction in the utility usage to be effected at a premises associated with the consumer; (e) verifying that the challenge is completed; (f) causing a bill to be delivered to a communication device associated with the consumer; and (g) generating an authentication request for payment of a bill, in response to a payment input at a communication device associated with the consumer.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in incentivizing adjustment of utility usage by a consumer, the method comprising:
receiving, at a computing device, from a utility provider, a challenge defining a reduction in a utility usage by a consumer, in exchange for an incentive;
causing, by the computing device, the challenge to be delivered to a communication device associated with the consumer; and
when the challenge is completed, causing the incentive to be awarded to the consumer, whereby the utility provider is able to affect utility usage by the consumer through the incentive-based challenge.

2. The computer-implemented method of claim 1, wherein the incentive includes a rebate and/or a discount associated with a merchant separate from the utility provider.

3. The computer-implemented method of claim 2, wherein the reduction in the utility usage includes a reduction in electricity usage.

4. The computer-implemented method of claim 1, wherein the challenge includes a predefined interval; and
wherein causing the incentive to be awarded includes causing the incentive to be awarded only after the challenge is completed consistent with the predefined interval.

5. The computer-implemented method of claim 1, further comprising:
causing the reduction in the utility usage to be effected at a premises associated with the consumer; and
verifying, by the computing device, that the challenge is completed.

6. The computer-implemented method of claim 5, wherein causing the reduction in the utility usage includes adjusting a setting of a utility device at the premises, such that a utility usage by the utility device is reduced over a predefined interval associated with the challenge.

7. The computer-implemented method of claim 6, wherein adjusting a setting of a utility device at the premises includes adjusting, by the computing device, via an API associated with the utility device, the setting of the utility device at the premises.

8. The computer-implemented method of claim 1, further comprising causing, by the computing device, a bill to be delivered to the communication device associated with the consumer.

9. The computer-implemented method of claim 8, further comprising generating, by the computing device, an authentication request for payment of the bill, in response to a payment input at the communication device from with the consumer.

10. A non-transitory computer-readable storage media comprising instructions, which, when executed by at least one processor, cause the at least one processor to:
cause a challenge to be displayed to a consumer at a communication device, the challenge including a proposed adjustment to utility usage in exchange for an incentive;
receive an acceptance, from the communication device, of the challenge;
transmit, to an incentive engine associated with the challenge, the acceptance of the challenge, thereby permitting the incentive engine to access at least one utility device at a premises of the consumer to implement said adjustment; and
indicate, to the communication device, a completion of the challenge and an award of the incentive, thereby permitting the consumer to redeem the incentive awarded in exchange for the adjustment to the utility usage.

11. The non-transitory computer-readable storage media of claim 10, wherein the instructions, when executed by the at least one processor, further cause the at least one processor to receive a selection of the challenge from a plurality of challenges, prior to causing the challenge to be displayed to the consumer.

12. The non-transitory computer-readable storage media of claim 11, wherein the instructions, when executed by the at least one processor, further cause the at least one processor to receive the plurality of challenges from the incentive engine.

13. The non-transitory computer-readable storage media of claim 10, wherein the instructions, when executed by the at least one processor, further cause the at least one processor to redeem the incentive based on a consumer selection of a merchant associated with the incentive.

14. The non-transitory computer-readable storage media of claim 13, wherein the instructions, when executed by the at least one processor, further cause the at least one processor, in connection with redeeming the incentive, to append a new account to a payment application at the communication device consistent with the redeemed incentive.

15. The non-transitory computer-readable storage media of claim 10, wherein the instructions, when executed by the at least one processor, further cause the at least one processor to:
retrieve a statement associated with a consumer's account with the utility provider, the statement indicating a balance due for utility usage less the incentive; and
initiate a transaction to pay the balance due through a payment account associated with the consumer.

16. A system for use in incentivizing consumers to adjust utility usage at premises, the system comprising:
a memory comprising a challenge data structure having a plurality of challenges available to consumers and defining a reduction in utility usage by the consumers in exchange for an incentive;
a processor in communication with the memory, the processor configured to:
select a challenge from the plurality of challenges in the challenge data structure relating to a reduction in utility usage by a consumer;
transmit the challenge to a communication device associated with the consumer;
monitor the utility usage for at least one utility device at a premises associated with the consumer, upon acceptance of the challenge by the consumer; and
when the challenge is completed, cause an incentive associated with the challenge to be awarded to the consumer.

17. The system of claim 16, wherein the memory further includes a utility provider data structure having a listing of consumers to whom utilities are provided by a utility provider; and
wherein the processor is further configured to select the consumer from the listing of consumers in the utility provider data structure based on a geographic location of the premises associated with the consumer.

18. The system of claim 17, wherein the memory further includes a consumer data structure having consumer preferences relating to acceptance of challenges transmitted by the processor; and
wherein the processor is configured to identify a consumer preference from the consumer data structure, for the consumer, permitting the processor to monitor the utility usage for the at least one utility device at the premises.

19. The system of claim 16, wherein the incentive includes a rebate and/or a discount associated with a merchant separate from the utility provider.

20. The system of claim 19, wherein the incentive includes a rebate; and
wherein the processor is further configured to transmit a statement to the communication device associated with the consumer for an account provided by a utility provider in connection with utility usage at the premises, the statement indicating a balance due for the utility usage at the premises less the rebate; and
initiate a transaction to pay the balance due through a payment account associated with the consumer.
